(19) United States
(12) Patent Application Publication
(10) Pub. No.: US 2007/0292736 A1
(43) Pub. Date: Dec. 20, 2007

(54) Fuel cell separator plate and method of forming same

(76) Inventors: Eve S. Steigerwalt, Nashville, TN (US); Casey Johnson, Paris, TN (US); Jack A.C. Kummerow, Paris, TN (US); Prometheus Kamperman, Paris, TN (US)

Correspondence Address: MARSHALL & MELHORN, LLC, FOUR SEAGATE, 8TH FLOOR, TOLEDO, OH, 43804, US

(21) Appl. No.: 11/471,081

(22) Filed: Jun. 20, 2006

(51) Int. Cl. H01M 8/02; B28B 5/00; B29C 45/14

(52) U.S. Cl. 429/34; 264/250; 264/259

(57) ABSTRACT

A method of forming a separator plate assembly for a fuel cell, including the steps of forming at least one electrode separator plate by molding a first component, placing the first component in a mold tool, and molding a second component into contact with the first component, wherein the first and second components include a conductive active portion and a non-conductive carrier.

### FIELD

A separator plate for fuel cell stacks and methods of forming same are disclosed and described herein.

### BACKGROUND

A fuel cell is a device that converts the chemical energy of fuels directly to electrical energy and heat. In its simplest form, a fuel cell comprises two electrodes—an anode and a cathode—separated by an electrolyte. During operation, a gas distribution system supplies the anode with fuel and the cathode with oxidizer. Typically, fuel cells use the oxygen in the air as the oxidizer and hydrogen gas (including hydrogen produced by reforming hydrocarbons) as the fuel. Other viable fuels include reformulated gasoline, methanol, ethanol, and compressed natural gas, among others. The fuel undergoes oxidation at the anode, producing protons and electrons. The protons diffuse through the electrolyte to the cathode where they combine with oxygen and the electrons to produce water and heat. Because the electrolyte acts as a barrier to electron flow, the electrons travel from the anode to the cathode via an external circuit containing a motor or other electrical load that consumes the power generated by the fuel cell.

A complete fuel cell generally includes a pair of separator plates or separator plate assemblies on either side of the electrolyte. A conductive backing layer may also be provided between each plate and the electrolyte to allow electrons to move freely into and out of the electrode layers. Besides providing mechanical support, the plates frequently define fluid flow paths within the fuel cell and collect current generated by oxidation and reduction of the chemical reactants. The plates are gas-impermeable and have channels or grooves formed on one or both surfaces facing the electrolyte. The channels distribute fluids (gases and liquids) entering and leaving the fuel cell, including fuel, oxidizer, water, and any coolants or heat transfer liquids. Each separator plate may also have one or more apertures extending through the plate that distribute fuel, oxidizer, water, coolant, and any other fluids throughout a series of fuel cells. Each separator plate is typically made of an electron conducting material including graphite, aluminum or other metals, and composite materials such as graphite particles imbedded in a thermosetting or thermoplastic polymer matrix. To increase their energy delivery capability, fuel cells are typically provided in a stacked arrangement of pairs of separator plates with electrolytes between each plate pair. In this arrangement, one side of a separator plate will be positioned adjacent to and interface with the anode of one fuel cell, while the other side of the separator plate will be positioned adjacent to and interface with the cathode of another fuel cell. Thus, the plate is referred to as “bipolar.”

Typical separator plates include an anode flow path on one surface and a cathode flow path on another surface. The plates may be integrally formed with both the anode and cathode surfaces. Alternatively, an anode plate and cathode plate may be separately formed and then combined to create a separator plate assembly. As indicated above, coolant channels are typically formed by the assembly process, due to grooves on one plate mating with a flat surface or matching grooves on the other plate.

Known composite separator plates for fuel cell stacks have become quite thin resulting in more fragile plates. In addition, the apertures mentioned above define manifold holes for supply of reactants and product removal. These areas are particularly vulnerable to cracks. Accordingly, improving the strength of the separator plate would improve the manufacturability of these plates.

### SUMMARY

A method of manufacturing a separator plate assembly begins by forming at least one electrode separator plate by molding a first component. The first component is then placed in mold tool. Next, a second component is molded into contact with the first component. The first and second components include a conductive active portion and a non-conductive carrier.

### BRIEF DESCRIPTION OF THE DRAWINGS

FIG. 1 is a schematic view of an embodiment of a fuel cell system.

FIG. 2 is a flowchart illustrating a method of forming a separator plate assembly according to one embodiment.

FIGS. 3-5 illustrate a method of forming a separator plate according to one embodiment.

FIGS. 6-8 illustrate an alternative method of forming a separator plate according to one embodiment.

FIG. 9 illustrates a plan view of a conductive active portion for a separator plate assembly.

FIG. 10 illustrates a plan view of a separator plate assembly according to one embodiment.

FIG. 11 illustrates a cross-sectional view of the separator plate assembly of FIG. 10 taken along line 11-11.

FIG. 12 is a plan view of a separator plate assembly according to one embodiment.

FIG. 13 is a cross-sectional view of the separator plate assembly of FIG. 12 taken along line 13-13.

### DETAILED DESCRIPTION

Various embodiments directed to a method for forming separator plates and separator plate assemblies for use in fuel cell systems are disclosed herein. The methods include initially forming a first component that may includes one or more attachment features and then molding a second component into contact with the second component. These components include, at least, a conductive active portion and a non-conductive carrier or frame. Separately forming a carrier and conductive portion may allow for increased design freedom and allow for forming durable separator plates and separator plate assemblies.

Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

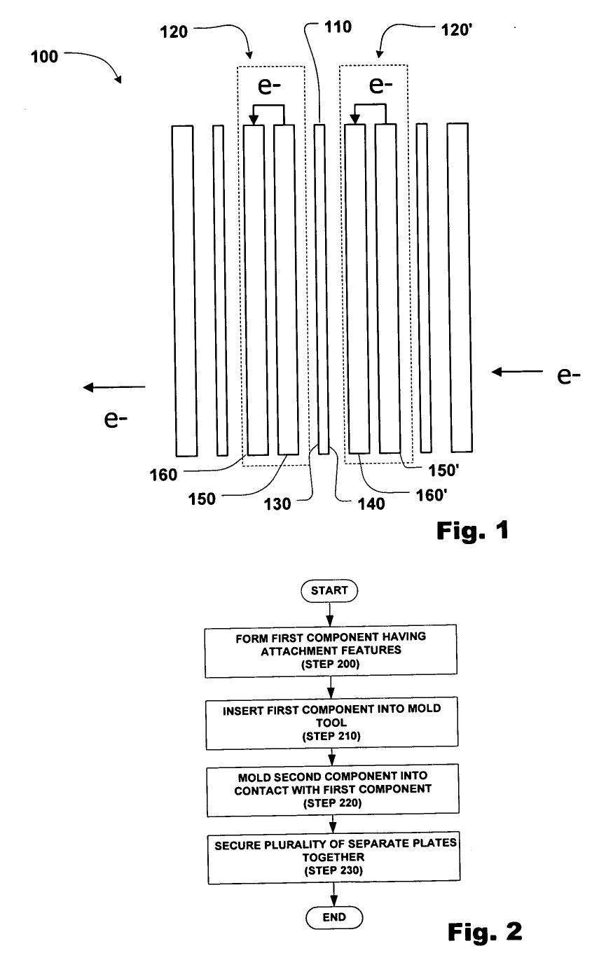

FIG. 1 illustrates a fuel cell system (100) that generally includes at least one fuel cell (110) and at least a first separator plate assembly (120). The fuel cell (110) includes opposing electrodes such as an anode, an electrolyte, and a cathode. Accordingly, the fuel cell (110) includes an anode surface (130) and a cathode surface (140).

The separator plate assembly (120) includes a plurality of electrode separator plates. These separator plates may include an anode separator plate (150) and a cathode separator plate (160). According to the embodiment shown in FIG. 1, the anode separator plate (150) and cathode separator plate (160) are electrically coupled to one another. In the embodiment illustrated in FIG. 1, the anode surface (130) is associated with the anode separator plate (150) of the first separator plate assembly (120). The cathode surface (140) is associated with a second separator plate assembly (120′). In particular, the cathode surface (140) is associated with a cathode separator plate (160′) of the second separator plate assembly (120′). This pattern may be repeated as many times as desired to form a series-type fuel cell stack. While a series-type configuration is shown, those of skill in the art will appreciate that separator plate assemblies as discussed herein may be adapted for use in other fuel cell system configurations.

As previously discussed, oxidant introduced to the anode surface (130) is split into protons and electrons. The fuel cell (110) shown acts as a barrier for the flow of electrons from the anode surface (130) to the cathode surface (140). Accordingly, the electrons produced at the anode surface (130) accumulate in the anode separator plate (150) of the first separator plate assembly (120).

The protons generated at the anode surface (130) migrate through the fuel cell (110) to the cathode surface (140). The presence of the protons on the cathode surface (140) produces an electron affinity in the cathode separator plate (160′) of the second separator plate assembly (120′). As fuel is introduced between the cathode plate (160′) and the cathode surface (140), the protons, electrons, and fuel combine to produce water and heat.

As introduced, the electrons generated at the anode surface (130) do not travel through the fuel cell, but rather accumulate in the anode separator plate (150). Further, as introduced, the cathode separator plate (160) is associated with the cathode surface of an adjacent fuel cell. This association produces the electron affinity in the cathode separator plate (160) discussed above with reference to the cathode separator plate (160′) of the second separator plate (120′). Thus, while fuel and oxidant are introduced to the fuel cell system (100), electron accumulation occurs in the anode separator plate (150) while an electron affinity is produced in the cathode separator plate (160). If the fuel cell is the last cell (or the only cell) in a stack, the anode separator plate (150) and cathode separator plate (160) are electrically coupled, such that electrons flow from the anode separator plate (150) through an electric circuit to the cathode separator plate (160), thus generating electricity. If the fuel cell is not the last cell of the stack, electrons pass through to the cathode surface 140.

Though not specifically shown in FIG. 1, each electrode separator plate includes multiple components such as an electrically conductive active portion and a separate non-conductive carrier. According to one embodiment, the non-conductive carrier is formed of a durable non-conductive material. Further, as will be discussed in more detail below, attachment features may be formed at the interface between the conductive active portion and the non-conductive carrier. Such features may increase the reliability of the electrode separator plate by securing the conductive active portion to the non-conductive carrier. As will be discussed in more detail below, one component of an electrode separator plate may be preformed. Thereafter, the other component(s) may be molded to the other components. Such a process may provide for increased durability of the separator plate as well as increasing the number of suitable types of processes that may be used in forming separator plates and separator plate assemblies, thus providing flexibility in designing and manufacturing separator plates and separator plate assemblies. A process will now be discussed briefly, followed by discussions of specific embodiments of a method of forming separator plates, as well as the resulting separator plates.

FIG. 2 is a flowchart illustrating a method of forming a separator plate assembly according to one exemplary embodiment. The method begins by molding a first component which may have at least one attachment feature (step 200). These components may include, without limitation, a conductive active portion or a non-conductive carrier portion. The non-conductive carrier portion may optionally have manifold openings defined therein. Such openings may provide fluidic pathways for inlet and exhaust oxidant, inlet and exhaust fuel, and inlet and exhaust coolant.

Once the first component has been formed, the first component may then be inserted into a mold tool (step 210), such as a compression mold tool. Thereafter, a second component is molded into contact with the first component (step 220). Consequently, if the first component molded is a conductive active portion, the conductive active portion is inserted into a mold tool and the non-conductive carrier or frame is molded around the conductive active portion. Similarly, if the first component is the non-conductive carrier, the non-conductive carrier is placed in a mold tool and the conductive active portion is molded into contact with the non-conductive carrier.

The above methods may be used to form individual separator plates, such as anode and cathode separator plates. Once the individual separator plates have been formed, two separator plates are then secured together (step 230). For example, according to one exemplary method, the electrode separator plates may be bonded together with conductive adhesives.

According to another exemplary method, two conductive active portions are first formed. Thereafter, the conductive active portions may be bonded together to form a bonded sub-assembly of conductive active portions. The sub-assembly of conductive active portions may then have additional components molded into contact therewith. For example, a non-conductive carrier may be molded directly into contact with the bonded sub-assembly of conductive active portions. Such a configuration would provide a single non-conductive carrier for a complete separator plate assembly rather than a separator plate assembly having two individual separator plates, each having a separate non-conductive carrier, which are then bonded together in the assembly. Additionally, a flexible material may be located at least partially between the two conductive active portions while the conductive active portions are being bonded to form a sub-assembly of conductive active portions. The flexible material may extend beyond the perimeter of the sub-assembly of bonded conductive active portions. The entire assembly may then undergo an overmolding process, whereby the perimeter portion and conductive active regions are overmolded with a gasket material to form a non-conductive carrier. Overmolding of the gasket material may include the formation of opening in the material to define manifold openings. Three exemplary methods and corresponding separator plates will now be discussed in detail.

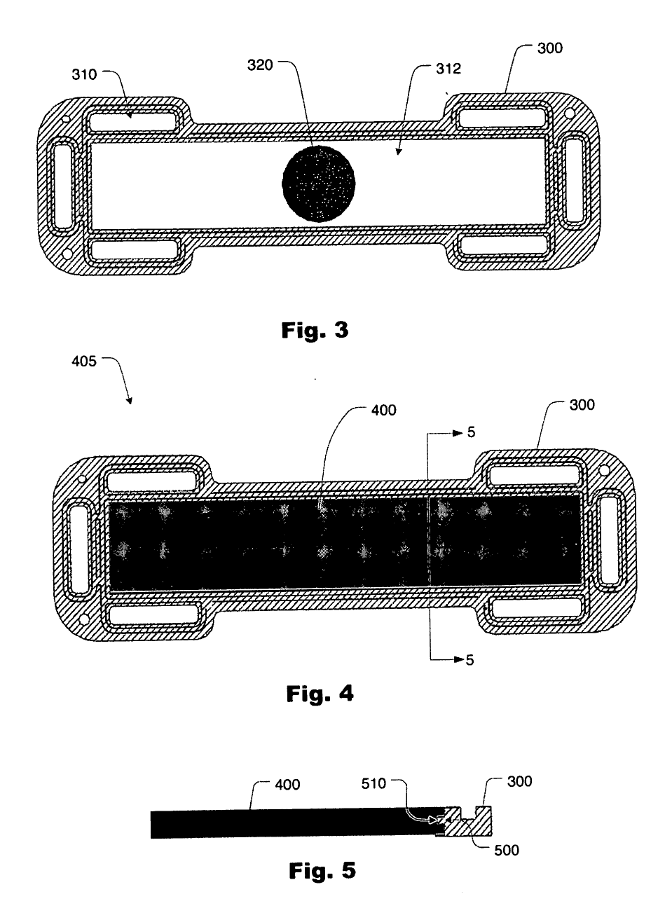

FIGS. 3-5 illustrate a method of forming a single electrode separator plate. In particular, FIG. 3 illustrates a preformed non-conductive carrier (300). As previously discussed, the non-conductive carrier may be formed of a durable, non-conductive material, such as a thermoplastic material. The non-conductive carrier may be formed by any suitable process, including, without limitation, injection molding or compression molding. Molding tools have been omitted from the drawings for ease of reference in illustrating and describing the features of each of the components as related to the described method. According to the embodiment illustrated in FIG. 3, the non-conductive carrier (300) may include a plurality of openings (310) defined therein. Such openings may be provided to direct oxidant, fuel, and coolant to the separator plates and/or fuel cells and to exhaust the byproducts out of the system. After the non-conductive carrier is formed, the non-conductive carrier (300) is placed into a molding tool, such as an injection mold. A conductive molding compound (320) is also placed in the mold, within a large central opening (312) formed through the non-conductive carrier (300).

As shown in FIG. 4, the conductive molding compound is then molded to form a conductive active portion (400). The conductive active portion (400) and non-conductive carrier (300) form a separator plate (405). The conductive active portion (400) may have any configuration suitable for use in a fuel cell. The conductive active portion (400) may be formed of an electron conducting composite material such as graphite particles imbedded in a thermoplastic or thermosetting polymer resin matrix. For example, composite materials comprising graphite particles imbedded in a vinyl ester matrix may be used.

Although not shown, each conductive active portion (400) may be shaped to define a desired pattern. For example, each side of the conductive active portion (400) may include grooves. In particular, if a surface of the conductive active portion (400) is to be placed adjacent a fuel cell anode, that surface may include a structure for distributing gases and liquids entering and leaving the fuel cell such as hydrogen entering the fuel cell. This structure may include structures such as channels and grooves. This structure may also include one or more apertures that cooperate with apertures on other separator plates to define a manifold for distributing fuel, oxidizer, water, coolant, and any other fluids throughout a series of cells. Similarly, if a surface of the conductive active portion (400) is to be placed adjacent to a fuel cell cathode, that surface may be configured similarly to an anode surface, the cathode surface having its own set of grooves or channels (e.g., for distributing oxygen entering the cell and/or water leaving the cell).

FIG. 5 illustrates a cross section of the separator plate of FIG. 4 taken along lines 5-5 in FIG. 4. As can be seen, the conductive active portion (400) is in contact with the non-conductive carrier (300). Contact between the conductive active portion (400) and the non-conductive carrier (300) may be increased by providing an attachment feature at the interface therebetween. As shown in FIG. 5, an example of an attachment feature includes a lap joint (500) that is positioned around the perimeter of the large central opening (312; FIG. 3). The lap joint (500) may be integrally formed with the non-conductive carrier (300). In one embodiment, lap joint (500) extends around the entire perimeter of the large central opening (312; FIG. 3). In another embodiment, the lap joint (500) may be provided only on select portions of the perimeter of the large central opening (312; FIG. 3). The lap joint (500) is molded in contact with the conductive active portion (400). Accordingly, FIGS. 3-5 illustrate one exemplary method of forming a separator plate by first forming a non-conductive carrier that may include one or more attachment features and then molding a conductive active portion into contact with the non-conductive carrier. While a protruding type attachment feature is shown, those of skill in the art will appreciate that other attachment features are possible, including a recessed attachment feature or any type of attachment feature.

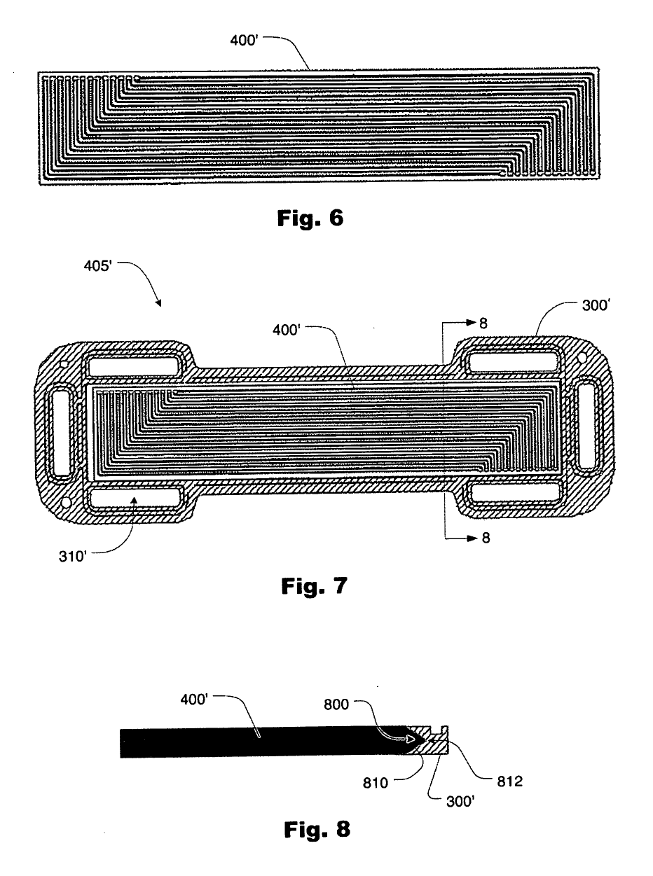

FIGS. 6-8 illustrate an alternative method of forming a separator plate. As seen in FIG. 6, a conductive active portion (400′) may first be formed. Suitable forming operations may include, without limitation, compression molding or injection molding. As previously discussed, the conductive active portion (400′) may be formed having any desired pattern thereon.

After the conductive active portion 400′ is formed, the conductive active portion (400′) may be placed into a molding tool, such as an injection mold or compression mold. Thereafter, a non-conductive carrier (300′) is molded around the conductive active portion (400′) to form a separator plate (405′). The non-conductive carrier (300′) may be formed of any suitable material, such as a non-conductive thermoplastic material. The assembled conductive active portion (400′) and non-conductive carrier (300′) are shown in FIG. 7. As shown in FIG. 7, the non-conductive carrier (300′) may have openings (310′) defined therein, such as manifold openings.

FIG. 8 illustrates a cross-sectional view of the non-conductive carrier (300′) in contact with the conductive active portion (400′) taken along lines 8-8 in FIG. 7. Contact between the conductive active portion (400′) and the non-conductive carrier (300′) may be increased by providing one or more attachment features at the interface therebetween. As shown in FIG. 8, one embodiment of a suitable attachment feature may include an angled lap joint (800) that is attached to a peripheral edge of the conductive active portion (400′) such that it extends outward from the conductive active portion (400′). In one embodiment, the angled lap joint (800) may be integrally formed with the conductive active portion (400′). The lap joint (800) may extend around the entire periphery of the conductive active portion (400′). Alternatively, one or more lap joints (800) of various sizes may be formed so as to extend from the peripheral edge of the conductive active portion (400′) at various intervals. Accordingly, FIGS. 6-8 illustrate one exemplary method of forming a separator plate by first forming a conductive active portion (400′) with one or more attachment features and then molding a non-conductive carrier (300′) into contact therewith.

As discussed with reference to FIG. 2, formation of a bipolar separator plate assembly includes coupling at least two conductive active portions together. To this point, two methods of forming separator plates include forming a first component having one or more attachment features and then molding a second component into contact with the first component. These separator plates may then be coupled together by any suitable process. The two exemplary methods discussed thus far have included non-conductive carriers having manifold openings defined therein. Such separator plates may be coupled together directly, such as by applying conductive adhesive between the each separator plate to form a separator plate assembly. According to another exemplary method discussed below, the separator plate may include a plurality of separator plates having a perimeter portion without manifold openings defined therein.

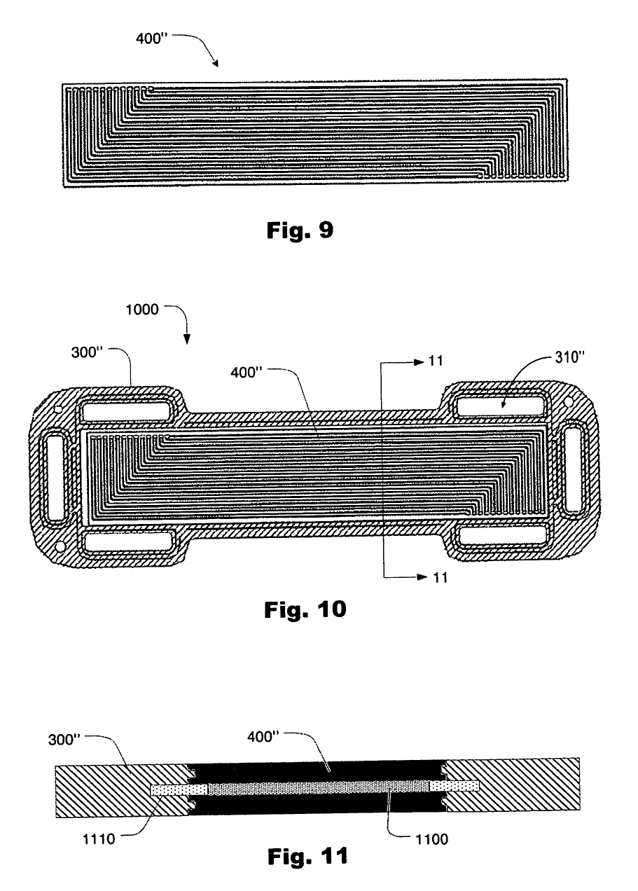

In particular, FIG. 9 illustrates a conductive active portion (400″). FIG. 10 illustrates a non-conductive carrier (300″) coupled to a plurality of conductive active portions (400″). The conductive active portions (400″) may be formed first and may include attachment features. Then, the other component may be molded into contact to form the separator plate assembly (1000). The non-conductive carrier (300″) may be non-flexible.

In particular according to one exemplary method, as illustrated in FIG. 11, which is a cross-sectional view of the separator plate assembly taken along section 11-11 in FIG. 10, the conductive active portions (400″) may be bonded together. For example, conductive adhesive (1100) may be used to bond the conductive active portions (400″). Further, a layer of flexible material (1110) may be placed at least partially between conductive active portions (400″) For example, a frame of thin flexible material (1110), such as Mylar, may be placed between the conductive active portions (400″). The entire assembly may then be placed in a mold tool and molded, such that the thin flexible material forms at least a partial perimeter having manifold openings defined therein. Alternatively, manifold openings may be formed in a separate gasketing operation. Further, the assembly then may also be subjected to a gasket molding process where the conductive active portion (400″) and the flexible frame are over-molded with gasket material to form a non-conductive carrier (300″). According to one exemplary embodiment, the gasket material may be molded to define manifold openings (310″) in the non-conductive carrier (300″), as seen in FIG. 10.

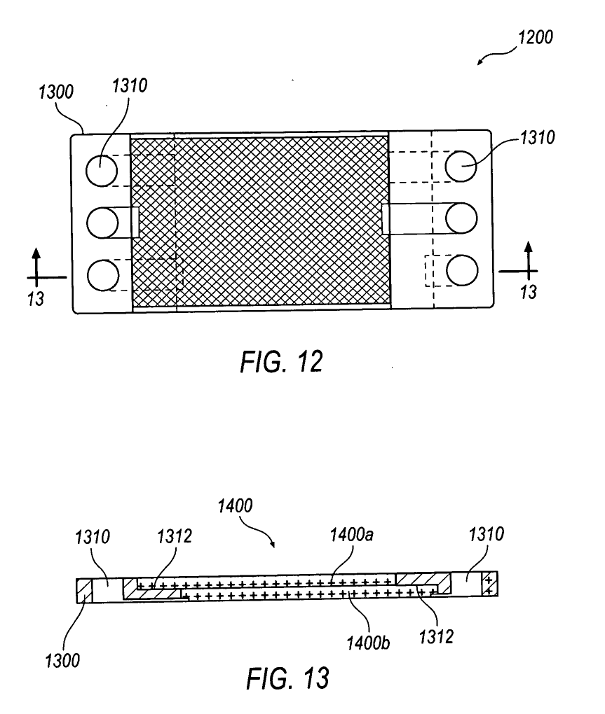

FIGS. 12-13 illustrate another embodiment of a separator plate assembly (1200). In assembly (1200), the conductive active portion (1400) is in contact with the non-conductive carrier (1300). Contact between the conductive active portion (1400) and the nonconductive carrier (1300) is increased by providing first and second conductive active portions (1400a and 1400b, respectively) whereby the first and second conductive active portions (1400a and 1400b)are offset from one another by a predetermined amount.

To accomplish the offset, the non-conductive carrier (1300) includes opposing mounting flanges (1312) that are formed on an interior wall of carrier (1300). The opposing mounting flanges (1312) cooperate to define a predetermined length opening into which each conductive active portion (1400a, 1400b) are positioned. In the representative embodiment shown, one a first side of the non-conductive carrier (1300), the mounting flange (1312) is spaced downwardly from a top face of non-conductive carrier. Accordingly, a first end of the first conductive active portion (1400a) is positioned in face-to-face contact with mounting flange (1312).

In contrast, on a second side of the non-conductive carrier (1300), the mounting flange (1312) is oriented such that the mounting flange (1312) so as to be substantially flush with the top face of the non-conductive carrier (1300). Accordingly, a second end of the second conductive active portion (1400b) is positioned in face-to-face contact with mounting flange (1312).

With the above described arrangement that is shown in FIGS. 12 and 13, the first conductive active portion (1400a) has a first end that is positioned outwardly from a first end of the second conductive active portion (1400b), when the conductive active portion (1400) is assembled with the non-conductive carrier (1300). Further, the second end of the second conductive active portion (1400b) is positioned outwardly from a second end of the first conductive active portion (1400a) when the conductive active portion (1400) is assembled with the non-conductive carrier (1300).

In conclusion, methods have been disclosed herein for forming separator plates and separator plate assemblies for use in fuel cell systems. The methods include initially forming a first component that may include one or more attachment features and then molding a second component into contact with the second component. These components include, at least, a conductive active portion and a non-conductive carrier. Separately forming a non-conductive carrier and conductive portion may allow for increased design freedom and allow for forming durable separator plates and separator plate assemblies.

The present disclosure has been particularly shown and described with reference to the foregoing embodiments, which are merely illustrative of the best modes for carrying out the disclosure. It should be understood by those skilled in the art that various alternatives to the embodiments of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A method of forming a separator plate assembly for a fuel cell, comprising the steps of:
forming at least one electrode separator plate by molding a first component;
placing said first component in a mold tool; and
molding a second component into contact with said first component,
wherein said first and second components include at least one conductive active portion and a non-conductive carrier.

2. The method of claim 1, wherein molding said first component includes injection molding said non-conductive carrier.

3. The method of claim 1, wherein molding said non-conductive carrier includes forming at least one attachment feature.

4. The method of claim 3, wherein forming said attachment feature includes forming a lap joint around at least a portion of a perimeter of said non-conductive carrier.

5. The method of claim 3, wherein forming said attachment feature includes forming opposing mounting flanges around at least a portion of a perimeter of said non-conductive carrier.

6. The method of claim 1, wherein molding said first component includes molding said non-conductive carrier from a thermoplastic material.

7. The method of claim 1, wherein molding said first component includes molding said conductive active portion.

8. The method of claim 7, wherein molding said conductive active portion includes forming at least one attachment feature.

9. The method of claim 8, wherein molding said conductive active portion includes forming a lap joint around at least a portion of a perimeter of said conductive active portion.

10. The method of claim 1, wherein forming said first component includes molding two conductive active portions and bonding said conductive active portions.

11. The method of claim 10, wherein said non-conductive carrier is non-flexible.

12. The method of claim 10, further comprising placing a flexible material at least partially between said two conductive active portions.

13. The method of claim 12, further comprising overmolding said flexible material and said conductive active portions to form a non-conductive carrier.

14. The method of claim 13, further comprising forming manifold openings in a perimeter of said non-conductive carrier.

15. A method of forming a separator plate assembly for a fuel cell in a compression molding operation, comprising the steps of:
forming at least one separator plate by molding at least one conductive active portion using conductive material; wherein said conductive action portion includes at least one attachment feature;
inserting said conductive active portion into a mold tool; and
molding a non-conductive carrier around said conductive action portion, whereby the attachment feature enables said conductive active portion to be attached to said non-conductive carrier.

16. The method of claim 15, wherein said mold tool is a compression mold.

17. The method of claim 15, wherein molding said non-conductive carrier includes molding a thermoplastic material.

18. The method of claim 15, wherein molding said non-conductive carrier includes molding manifold openings into said non-conductive carrier.

19. The method of claim 15, further comprising forming a plurality of separator plates and bonding a plurality of said conductive active portions together.

20. The method of claim 19, further comprising forming two conductive active portions, placing a flexible material at least partially between said conductive active portions, bonding said conductive active portions such that said flexible material extends beyond a perimeter of said conductive active portions, and molding a non-conductive carrier over said flexible material and into contact with said conductive active portions.

21. A separator plate assembly, comprising:
at least one conductive active portion;
a non-conductive carrier portion coupled to at least a portion of said conductive active portion, wherein at least one attachment feature is defined at a portion of an interface between said conductive active portion and said non-conductive carrier.

22. The assembly of claim 21, further comprising a plurality of conductive active portions bonded together with a flexible material surrounding a least portion thereof, said non-conductive carrier being molded over said flexible material.

23. The assembly of claim 21, wherein said attachment feature includes a lap joint.

24. The method of claim 21, wherein said attachment feature includes opposing mounting flanges.
